(19) United States
(12) Patent Application Publication
(10) Pub. No.: US 2016/0193862 A1
(43) Pub. Date: Jul. 7, 2016

(54) PRE-MANUFACTURED UNPRINTED ALBUM ON WHICH PHOTOS CAN BE PRINTED, ALBUM MANUFACTURING DEVICE USING SAME, AND METHOD FOR MANUFACTURING SAME

(71) Applicant: Yong Han JEE, Seoul (KR)

(72) Inventor: Yong Han JEE, Seoul (KR)

(21) Appl. No.: 14/916,823

(22) PCT Filed: Jan. 22, 2014
(86) PCT No.: PCT/KR2014/000608

§ 371 Date: Mar. 4, 2016

(30) Foreign Application Priority Data
Oct. 17, 2013 (KR) 10-2013-0123697

(51) Int. Cl. B42D 1/08; B41J 11/00; B42D 3/00

(52) U.S. Cl. CPC B42D 1/08; B42D 3/00; B41J 11/0015

(57) ABSTRACT

The present invention discloses a pre-manufactured unprinted photo album on which photographic images can be printed, and an apparatus and method for manufacturing a photo album using the same. Internal blank papers and a good-quality album cover sheet are bound to prepare semi-finished photo albums, and a photo album selected by a customer is opened in a photo studio so as to instantly print photographic images on surfaces of the photo album, thereby reducing the waiting time. Selection of the type of photo album and acquisition of a finished photo album can be quickly implemented. Since a semi-finished photo album, which is previously checked, is used, there is no problem of delayed acquisition of the finished photo album or of performing the process of manufacturing the photo album again. Since various semi-finished photo albums can be mass-produced, standardization of photo album is achieved, thereby reducing the manufacturing cost.

### TECHNICAL FIELD

The present invention relates to a photo album, and more particularly to a pre-manufactured unprinted photo album on which photographic images can be printed, and an apparatus and method for manufacturing a photo album using the same, in which a plurality of internal papers on which photographic images are not printed and an album cover sheet having good quality are bound so as to prepare various types of semi-finished photo albums, and a preferred photo album, which is selected by a customer, is opened in a photo studio such that photographic images, which are taken by the customer, are instantly printed on printable surfaces of the photo album, thereby reducing the waiting time taken to obtain the finished photo album on which ceremonial photographs are printed.

### BACKGROUND ART

A photo album, which stores photographs, which are taken to mark anniversaries such as a first birthday, one hundred day, a wedding or a graduation, was disclosed in Korean Unexamined Patent Publication No. 10-2012-0016758 (publication date: Feb. 27, 2012). According to this publication, a commemorative photo album is manufactured in a way such that photographic images are printed on a photo paper, a groove is continuously formed in a side marginal region of the photo paper, the photo paper having the groove formed therein is coated with a coating film, upper and lower marginal regions of the photo paper are cut out such that opposite ends of the groove are exposed, a plurality of photo papers which include the grooves, which are exposed at opposite ends thereof, are stacked with each other, cover sheets having good quality are placed on the front and rear surface of the photo paper stack, and the photo papers and the cover sheets are bound. This photo album allows the pages to be smoothly turned, and furthermore allows even intermediate pages to be smoothly turned.

The process of manufacturing such a conventional photo album will now be described in detail. First, photographic images, which are taken in order to manufacture a photo album, are output to a plurality of printable papers in a retail photo studio, and the plurality of album papers including the photographic images printed thereon and manufacturing information such as the dimensions and materials of a photo album, which are requested by a customer are sent to an album factory.

After the individual photo studio sends the plurality of photo papers including the photographic images printed thereon to the album factory, the plurality of photo papers 12, which are to be loaded into the photo album, are folded along central folding lines 12a in the album factory, as illustrated in FIG. 1(a). At this time, the folding line 12a may be optionally selected depending on the orientation and content of the photo paper 12 to be loaded. By folding the photo paper in this way, a folded photo paper 12 is obtained, as illustrated in FIG. 1(b). The folded photo paper 12 may be selectively provided on the outer surfaces of the half papers with reinforcing mounts 11 in order to increase the volume of the photo album, as illustrated in FIG. 1(c), which contributes to an improvement in the quality of the photo album. This technology is specifically disclosed in Korean Patent Registration No. 10-0801191 (registration date: Mar. 19, 2009).

More specifically, the photo papers 12, which have been sent to the album factory, are individually attached to reinforcing mounts 11 having a predetermined thickness so as to prevent the photo papers 12 from being folded, thereby providing elementary internal album papers. Thereafter, a photo protective coating agent or protective film is selectively applied to the surfaces of the elementary internal papers including the photographic images printed thereon. A plurality of elementary internal album papers are stacked with each other such that the photo papers 12 are sufficiently attached to the reinforcing mounts 11. The stacked elementary internal papers are pressed and aged for about three days such that the photo papers are stably secured to the reinforcing mounts 11. After the bonding surfaces of the internal papers are sufficiently stabilized, the marginal regions of the plurality of elementary internal papers, which are stacked with each other, are cut out in accordance with the dimensions of the photo album to be manufactured, and cover sheets, which are previously prepared, are attached to the elementary internal papers, thereby completing the photo album, which was ordered by the customer.

However, there are problems in that it takes a lengthy period of three days to seven days to transfer the plurality of photo papers including photographic images printed thereon to the album factory and to receive the finished final photo album, thereby deteriorating productivity. Furthermore, since a plurality of internal papers are prepared from photo papers including photographic images printed thereon, and the final photo album is manufactured from the plurality of internal papers, the series of manufacturing processes have to be performed again from the start when it is found that the finished photo album contains a small local defect, which is very problematic.

In addition, there are a technology of arranging a printing sheet and a binding sheet with a predetermined distance therebetween and coating the printing sheet and the binding sheet with a protective film, which is disclosed in Korean Patent Registration No. 10-0801191 (registration date: Jan. 29, 2008), and technologies disclosed in Korean Unexamined Publication No. 10-2010-0096416 (publication date: Sep. 2, 2010) and Korean Patent Registration No. 10-1033714 (registration date: Apr. 29, 2011). However, since these technologies also necessarily requires a procedure of trimming photo papers including photographic images printed thereon and a procedure of arranging the photo papers and binding sheets with a predetermined distance therebetween, it is not easy to manufacture the photo album. Furthermore, when the entire area of the printing paper is coated with a protective film, the inherent texture of special paper, which constitutes the printing paper and is relatively expensive, and the feeling of the printed images are seriously deteriorated due to the presence of the protective film, thereby marring the feeling of a luxurious photo album. In addition, according to these technologies, since the bent areas of album papers are not printed, it is impossible to completely realize a large-sized image, which is continuously printed on two pages of photo papers. Furthermore, even when a photographic image is printed on a single photo paper, since the photographic image is interrupted at the bent area, the level of finish of the photo album is not satisfactory, thus making it difficult to obtain a luxurious photo album.

### DISCLOSURE

### Technical Problem

Therefore, the present invention has been made in view of the above problems, and it is an object of the present invention to provide a pre-manufactured unprinted photo album on which photographic images can be printed, and a method of manufacturing the same, in which a plurality of internal papers on which photographic images are not printed and an album cover sheet having good quality are bound so as to prepare various types of semi-finished photo albums, and a preferred photo album, which is selected by a customer, is opened in a photo studio such that photographic images, which are taken by the customer, are instantly printed on printable surfaces of the photo album, thereby reducing the waiting time taken to obtain the finished photo album on which ceremonial photographs are printed.

According to the present invention, the selection of the type of photo album and the acquisition of the finished photo album can be quickly implemented. In addition, since a semi-finished photo album, which is checked in advance, is used, there is no problem of delayed acquisition of the finished photo album due to the occurrence of a defect in the manufacturing process or of performing the process of manufacturing the photo album again from the start when a damaged portion is found. Furthermore, since various types of semi-finished photo albums can be mass-produced, the standardization of photo albums is achieved, thereby remarkably reducing the cost of manufacturing photo albums.

Another object of the present invention is to provide an apparatus for manufacturing a photo album, which is suitable for instantly printing photographic images, which are taken on location, in a semi-finished photo album or respective photo papers thereof, which are checked in order to detect defects.

A further object of the present invention is to provide a pre-manufactured unprinted photo album on which photographic images can be printed, and a method of manufacturing the same, which are able to realize a large-sized photographic image printed on two pages by continuously printing the photographic image on both sides of an opened printable surface using a flat-board printer.

### Technical Solution

In order to achieve the above objects, a pre-manufactured unprinted photo album on which photographic images are to be printed, includes a plurality of first reinforcing mounts, a plurality of internal album papers, each of which is folded along a central folding line thereof, inner surfaces of the folded internal album paper, which face each other, serving as printable surfaces on which photographic images are to be printed and outer surfaces of the folded internal album paper, which are opposite the inner surfaces, being attached to the first reinforcing mount by means of an adhesive, a U-shaped reinforcing fabric strap, which includes a first fixing portion, which is adhesively attached to outer surfaces of folded portions of the internal album papers so as to surround the outer surfaces when the plurality of internal album papers and the plurality of first reinforcing mounts are stacked with each other, and second fixing portions, which extends from both lateral ends of the first fixing portion and are attached to outermost ones of the plurality of internal album papers so as to surround outer surfaces of outermost ones of the first reinforcing mounts, and an album cover sheet, which defines a U-shaped non-adhesive space for accommodating the reinforcing fabric strap and covers the reinforcing fabric strap, which surrounds the central folded portions of the internal album papers, the album cover sheet including first and second support layers serving as front and rear cover plates, a third support layer serving as an intermediate cover plate and a surface skin layer enveloping the first to third support layers, the surface skin layer having folding portions, which are positioned between the first to third support layers so as to be flexibly bent, and adhesively attaching inner surfaces of the first and second support layers to the internal album papers.

In an aspect of the present invention, first and final papers of the plurality of internal album papers may be provided with second reinforcing mounts adhesively attached to surfaces thereof contacting the album cover sheet so as to reliably maintain the contacting surfaces in the attached state.

In another aspect of the present invention, the plurality of internal album papers may be made of papers or synthetic films which are not treated with a printing solution, and the inner surfaces of the plurality of internal album papers are coated with an aqueous gelatin solution so as to form printable surfaces.

In still another aspect of the present invention, the aqueous gelatin solution may be prepared by mixing water and gelatin at a volume ratio of 80˜120:1.

In yet another aspect of the present invention, the folded portion of each of the plurality of internal album papers may form a folding extension having a semicircular cross-section and extending beyond a width of the first reinforcing mounts so as to accommodate a thickness of the first reinforcing mount and the thickness of the reinforcing fabric strap surrounding a stacked and bound portion of the internal album papers and the first reinforcing mounts when the internal album paper is unfolded in the state in which the photo album is finished.

In still yet another aspect of the present invention, the album cover sheet may include the first and second support layers, which are adhesively attached to outermost surfaces of the internal album papers and have a predetermined thickness, the third support layer, which is disposed between the first and second support layers with predetermined distances therebetween and which surrounds the reinforcing fabric strap and has a predetermined thickness, and a surface skin layer, which is attached to the first to third support layers so as to connect them to each other and which is provided between the first and second support layers and the third support layer with folding portions B, which have a smaller thickness than that of the support layers and are not attached to the internal album papers.

In a further aspect of the present invention, the surface skin layer may include a mesh layer attached to surfaces of the first to third support layers, a cushion layer, which is disposed on a surface of the mesh layer so as to provide a cushioning function, and an outer skin layer, which is disposed on a surface of the cushion layer and has a predetermined stretching property.

An apparatus for manufacturing a photo album according to the present invention includes a printer for printing photographic images on a printable surface of an opened pre-manufactured photo album transferred through a transfer conveyer by jetting printing ink onto the printable surface through a nozzle thereof, the photo album being bound and not being printed with photographic images, a page-turning unit for, after the photographic images are printed on the printable surface of the opened photo album, turning a next paper of the photo album so as to print photographic images on a next page, first and second balancers for supporting an album cover sheet of the pre-manufactured unprinted photo album while moving vertically such that a height difference between both sides of the photo album, which is formed when pages of the internal album papers are turned one by one by the page-turning unit and are printed with photographic images, is compensated for, whereby an effective gap between the printable surface and a nozzle for jetting printing ink is maintained consistent, a first dryer for, after the internal album paper is printed with the photographic images in the state in which the balanced state between both sides of the photo album is maintained, drying the photographic images printed on the internal album paper, a coater for coating the printable surface, which has been provided with the photographic images dried by the first dryer, with a protective film, and a second dryer for drying the printable surface, which has been coated by the coater.

In an aspect of the present invention, when the pre-manufactured photo album, which is not printed with photographic images and bound, is sequentially transferred to the printer, the first dryer, the coater and the second dryer along the transfer conveyer so as to be dried and coated with the protective film, the first and second balancers may maintain the both sides of the photo album in the balanced state.

In another aspect of the present invention, the apparatus may further include a photo printing film-coating unit, which is disposed in front of the printer.

In still another aspect of the present invention, the printer may be an inkjet-type flat-board printer.

In yet another aspect of the present invention, the coater may include a patterning unit, which makes a coating thickness of a protective film uniform or provides a protective film having various shapes and images in order to provide a printed photograph with a steric effect or a catadioptric effect.

A method of manufacturing a photo album according to the present invention includes a first operation of selecting a pre-manufactured unprinted photo album, which is bound in a state of not being printed with photographic image, a second operation of checking the pre-manufactured unprinted photo album, which has been selected in the first operation, a third operation of placing the pre-manufactured unprinted photo album, which has been checked in the second operation, on a transfer conveyer of a photo album-manufacturing apparatus so as to open internal album papers of the photo album, and printing photographic images on a printable surface of the opened internal album papers, a fourth operation of drying the printable surface of the internal album papers, on which the photographic images have been printed in the third operation, a fifth operation of coating the printable surface of the internal album papers having the photographic images printed thereon, which has been dried in the fourth operation, with a protective film having a predetermined thickness or pattern, a sixth operation of drying the protective film, which has been applied to the printable surface in the fifth operation, and a seventh operation of, after the sixth operation, repeating the third to fifth operations while sequentially turning pages of the internal album papers, thereby consecutively printing photographic images on printable surfaces of the internal album papers.

In an aspect of the present invention, the method may further include an operation of maintaining equal heights of both sides of the internal album papers using first and second balancers while the printable surfaces of the internal album papers are consecutively printed with photographic images while the pages of the internal album papers are turned in the fourth and seventh operations.

### Advantageous Effects

In the pre-manufactured unprinted photo album on which photographic images can be printed and the method of manufacturing the same, a plurality of internal papers on which photographic images are not printed and an album cover sheet having good quality are bound so as to prepare various types of semi-finished photo albums, and a preferred photo album, which is selected by a customer, is opened in a photo studio such that photographic images, which are taken by the customer, are instantly printed on printable surfaces of the photo album, thereby reducing the waiting time taken to obtain the finished photo album on which ceremonial photographs are printed.

According to the present invention, the selection of the type of photo album and acquisition of the finished photo album can be quickly implemented. In addition, since a semi-finished photo album, which is previously checked, is used, there is no problem of delayed acquisition of the finished photo album due to occurrence of defects in the manufacturing process or of performing the process of manufacturing the photo album again from the start when a damaged portion is found. Furthermore, since various types of semi-finished photo albums can be mass-produced, standardization of photo albums is achieved, thereby remarkably reducing the cost of manufacturing photo albums.

### DESCRIPTION OF DRAWINGS

The above and other objects, features and other advantages of the present invention will be more clearly understood from the following detailed description taken in conjunction with the accompanying drawings, in which:

FIG. 1 is a view showing an attached structure of reinforcing mounts and internal album papers, which constitute a pre-manufactured unprinted photo album according to an embodiment of the present invention;

FIG. 2 is a view showing the reinforcing mounts and the internal album papers, which are stacked with each other, and a reinforcing fabric strap attached thereto, according to the present invention;

FIG. 3 is a perspective view showing an album cover sheet according to the embodiment of the present invention;

FIG. 4 is a schematic cross-sectional view showing the album cover sheet adhesively attached to the reinforcing mounts, the internal album papers and the reinforcing fabric strap according to the embodiment of the present invention;

FIG. 5 is a schematic cross-sectional view showing the pre-manufactured unprinted album according to the embodiment of the present invention, which is opened in the state in which both sides of a printable surface are positioned at the same height;

FIG. 6 is a schematic cross-sectional view showing the pre-manufactured unprinted album according to the embodiment of the present invention, which is opened in the state in which both sides of a printable surface are positioned at different heights;

FIG. 7 is a schematic view showing an apparatus for manufacturing a photo album according to an embodiment of the present invention; and

FIG. 8 is a flowchart showing a process of manufacturing a final photo album by printing photographic images on the internal album papers of the pre-manufactured unprinted photo album according to an embodiment of the present invention.

### BEST MODE

Hereinafter, embodiments of the present invention are described with reference to the accompanying drawings.

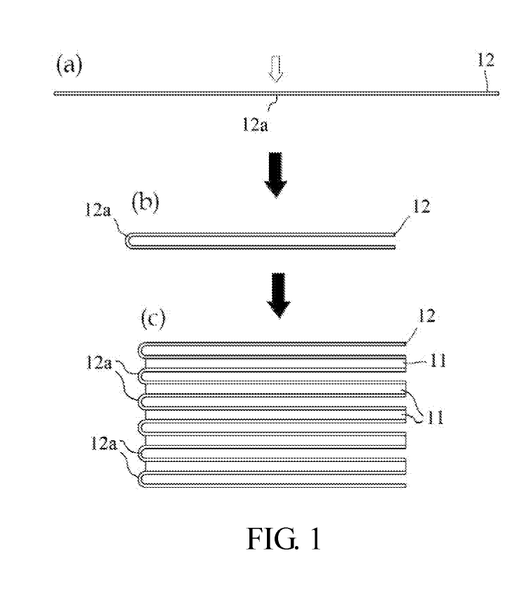

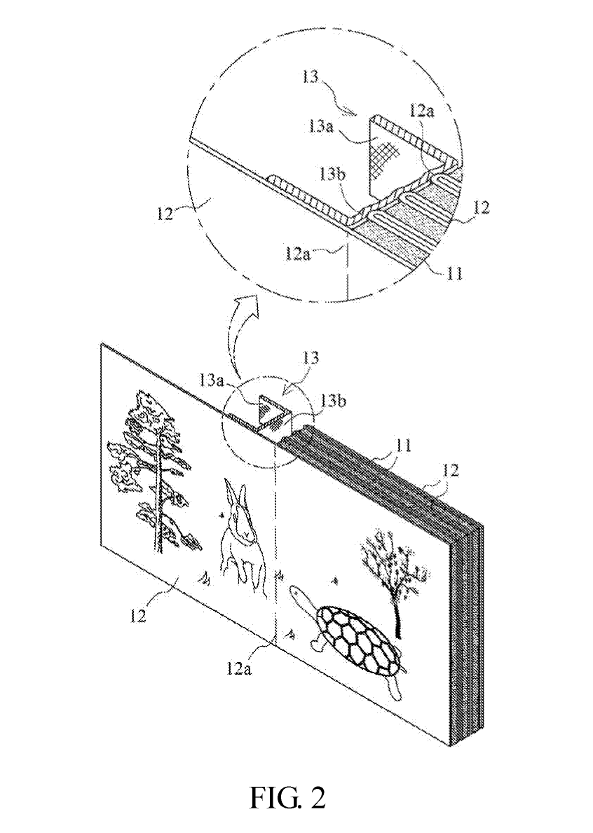

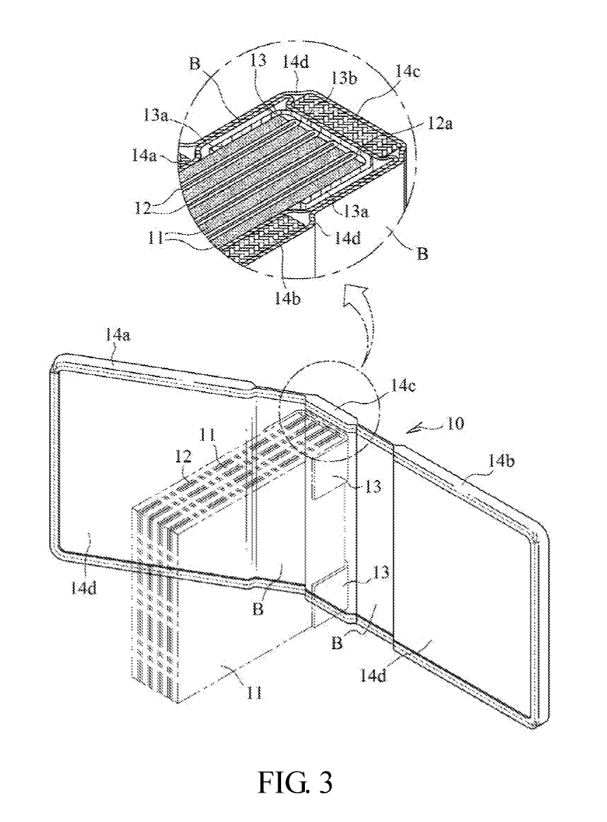

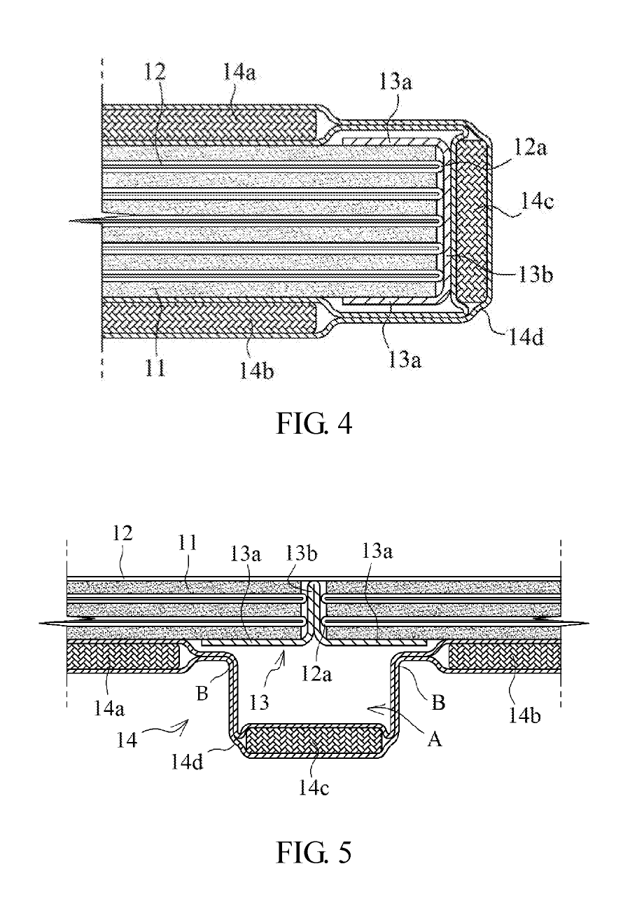

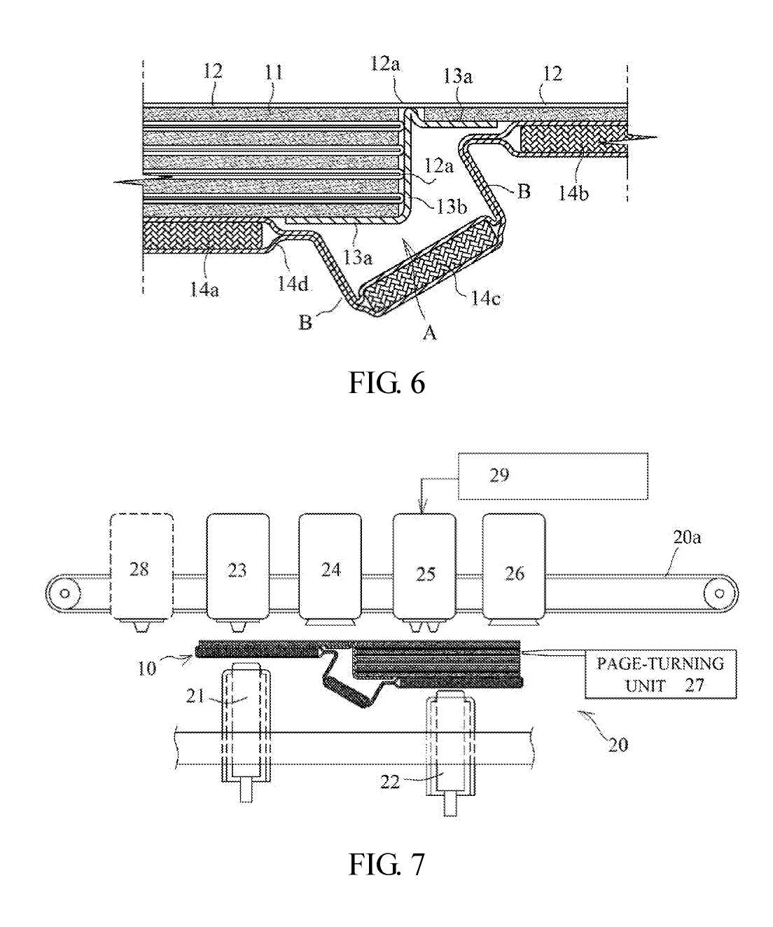

FIG. 1 is a view showing an attached structure of reinforcing mounts and internal album papers, which constitute a pre-manufactured unprinted photo album according to an embodiment of the present invention. FIG. 2 is a view showing the reinforcing mounts and the internal album papers, which are stacked with each other, and a reinforcing fabric strap attached thereto, according to the present invention. FIG. 3 is a perspective view showing an album cover sheet according to the embodiment of the present invention. FIG. 4 is a schematic cross-sectional view showing the album cover sheet adhesively attached to the reinforcing mounts, the internal album papers and the reinforcing fabric strap according to the embodiment of the present invention. FIG. 5 is a schematic cross-sectional view showing the pre-manufactured unprinted album according to the embodiment of the present invention, which is opened in the state in which both sides of a printable surface are positioned at the same height. FIG. 6 is a schematic cross-sectional view showing the pre-manufactured unprinted album according to the embodiment of the present invention, which is opened in the state in which both sides of a printable surface are positioned at different heights.

Referring to FIGS. 1 to 6, the photo album 10 according to an embodiment of the present invention includes first reinforcing mounts 11, internal papers 12, reinforcing fabric straps 13 and an album cover sheet 14.

The first reinforcing mounts 11 are adhesively secured between the internal album papers 12. Each of the internal album papers 12 is folded along a central folding line thereof, and the folded internal papers 12 are provided on inner surfaces thereof that face each other with printable surfaces on which photographs are to be printed. The outer surfaces of the folded internal paper 12, which are positioned opposite the printable surfaces are adhesively attached to the first reinforcing mounts 11 by means of adhesive.

The central folded portion of the photo internal paper 12 is provided with a folding extension 12a having a semicircular cross-section so as to accommodate the thickness of the first reinforcing mount 11 and the thickness of the reinforcing fabric strap 13 surrounding the internal album papers 12 and the first reinforcing mounts 11 when the internal album paper is unfolded in the state in which the photo album is finished.

The outermost internal papers of the folded internal papers, which are stacked one on another, are provided with second reinforcing mounts 12b attached thereto, so as to stably maintain the surfaces thereof in the state of being attached to the album cover sheet 14.

The pre-manufactured unprinted photo album according to the present invention may be constituted by internal album papers 12, which are made of various general plain papers such as papers or synthetic films to which printing solution is not applied. In this case, prior to printing photographic images on the inner surfaces of the internal album papers 12, the internal album papers 12, which are made of general plain papers, are converted into printable surfaces on which photographic images can be printed, by applying aqueous gelatin solution to the general plain papers.

The aqueous gelatin solution, which is applied to the surfaces of the internal album papers 12 in order to convert general plain papers into printable surfaces on which photographic images can be printed, may be prepared by mixing water and gelatin with each other at a volume ratio of 80˜120:1.

The internal album papers 12 may be selectively made of materials having sufficient rigidity to resist tearing. Specifically, the internal album papers 12 may be made of a highly-absorbent material such as traditional Korean paper so as to allow the surfaces thereof to be converted into printable surfaces by applying aqueous gelatin solution to the surfaces.

Each of the reinforcing fabric straps 13, which is a U-shaped structure adapted to surround the outermost surfaces of the internal album papers 12 as well as the stacked and bound region of the first reinforcing mounts 11 and the internal album papers 12, includes first fixing portions 13a, which are adhesively attached to the outermost surfaces of the internal album papers 12 so as to surround the outermost surfaces when the internal album papers 12 are folded along the folding lines and stacked to the first reinforcing mounts 11, and a second fixing portion 13b, which is attached to the stacked and bound region of the first reinforcing mounts 11 so as to be folded and to surround the stacked and bound region when the internal album papers 12 are unfolded.

The album cover sheet 14 is attached to the internal album papers 12 so as to define a U-shaped space A in which the reinforcing fabric straps 13 are accommodated when the internal album paper 12 is folded along a central folding line thereof and so as to surround and protect the internal album papers 12 and the reinforcing fabric straps 13 when the internal album paper 12 is unfolded. The album cover sheet 14 includes first and second support layers 14a and 14b, a third support layer 14c and a surface skin layer 14d consecutively enveloping the support layers 14a, 14b and 14c.

The first and second layers 14a and 14b, which are enveloped by the surface skin layer 14d, have a predetermined thickness and are securely attached to the outermost surfaces of the internal album papers 12.

The third support layer 14c, which defines a folding space with the first and second support layers 14a and 14b, which are somewhat spaced apart from each other, has the same thickness as the first and second support layers 14a and 14b. Consequently, the reinforcing fabric straps 13 are disposed in the folding space defined between the first and second support layers 14a and 14b and the third support layer 14c, and are surrounded by the first and second support layers 14a and 14b and the third support layer 14c.

Although the first to third support layers 14a, 14b and 14c may be made of laminated papers, MDFs, synthetic resin, metal or the like, the present invention is not necessarily limited thereto.

The surface skin layer 14d, which is attached to the first to third support layers 14a, 14b and 14c so as to connect them to each other, is provided between the first and second support layers 14a and 14b and the third support layer 14c with folding portions B, which are thinner than the support layers. Although not shown in the drawings, the surface skin layer 14d may include a mesh layer attached to the surfaces of the first to third support layers 14a, 14b and 14c, a cushion layer, which is disposed on the surface of the mesh layer so as to provide a cushioning function, and an outer skin layer, which is disposed on the surface of the cushion layer and has a predetermined stretching property.

The outer skin layer may be made of leather, artificial leather, papers, silk, cloth, PVC, PP, PE or the like. Photographic images may be printed on the outer skin layer using ultraviolet curable ink through ink-jet printing, and may be cured and fixed to the outer skin layer using an ultraviolet irradiator. The mesh layer may be provided on the surface thereof with an adhesive so as to be adhesively attached to the surface of the support layer.

The cushion layer may be made of synthetic leather or PVC leather having a foamed layer, PU leather having a cast foam layer, EVA or high density latex, PP foam long fiber or the like, or may, of course, be selectively made of cashmere (artificial fabric).

As shown in FIG. 7, an apparatus for manufacturing a photo album using the pre-manufactured unprinted photo album on which photographic images can be printed, shown in FIGS. 1 to 6, includes a printer 23, a first dryer 2, a coater 25 and a second dryer 26, which are sequentially disposed along a transfer conveyor 20a, and first and second balancers 21 and 22 and a page-turning unit 27, which are transferred along the transfer conveyer 20a. Although not specifically illustrated in the drawing, the apparatus 20 is provided with the page-turning unit 27 for sequentially turning the internal album papers of the pre-manufactured unprinted photo album on which photographic images can be printed.

The printer 23 functions to print photographic images by applying photo printing ink to the surfaces of the internal album papers of the pre-manufactured unprinted album on which photographic images can be printed, which is subjected to a bookbinding process and is transferred along the transfer conveyer 20a, while sequentially opening the first to final internal papers of the album. The photo printer is preferably embodied as an inkjet-type flat-board printer.

The first dryer 24 serves to dry the photographic images printed on the internal album papers, and the protective film coater 25 serves to coat the dried photographic image with a protective film. The second dryer 26 serves to stabilize the protective film applied to the printed photographic images.

The protective film coater 25 is preferably provided with a patterning unit 29 for making the thickness of the protective film uniform or providing the protective film with various patterns and images. The patterning unit 29 serves to jet coat liquid in a predetermined pattern, including shapes, images, characters and logos, corresponding to the photographic image printed by the printer 23, thereby offering a steric effect or a catadioptric effect owing to the embossed protrusions on the printed photographic image.

When the pre-manufactured unprinted photo album, which is guided by the transfer conveyer 20a, sequentially passes through the printer 23, the first dryer 24, the coater 25 and the second dryer 26, the pre-manufactured unprinted photo album is maintained in the horizontally balanced state by means of the first and second balancers 21 and 22, which are vertically moved, even though the internal album papers of the pre-manufactured unprinted photo album are turned.

Specifically, when photographic images are printed on the printable surfaces by the printer 23, the first and second balancers 21 and 22 are intended to support the cover sheet of the pre-manufactured unprinted photo album while being vertically moved such that the height difference between the both sides of the pre-manufactured unprinted photo album is compensated for, whereby the effective gap between the printable surfaces and the nozzle of the printer 23, adapted for jet-printing ink, is uniformly maintained. Furthermore, when the pre-manufactured unprinted photo album is dried and coated with a protective film while being sequentially transferred to the first dryer 24, the coater 25 and the second dryer 26 along the transfer conveyer 20a, the cover sheet of the pre-manufactured unprinted album is supported in the state in which the both sides of the internal album papers 12 are maintained in the balanced condition.

The page-turning unit 20, which is intended to sequentially turn over the internal album papers 12, may be selectively embodied as one of various simple devices, which are disclosed in Korean Unexamined Patent Publication No. 10-1999-000763, Korean Utility Model Registration No. 20-0326208, which is directed to a page-turning device using a magnet, Korean Utility Model Registration No. 20-0267372, which is directed to a page-turning device using suction force, and the like. In the present invention, the page-turning unit 27 may be embodied as any device as long as it is able to replace a printed surface of the internal album papers 12 with an adjacent surface of the internal album papers 12 to be printed. Accordingly, since it is not necessary to particularly specify the page-turning unit, a detailed description thereof is omitted in the following disclosure.

The apparatus may further include a photo printing film-coating unit 28 (for example, for applying aqueous gelatin solution), which is disposed in front of the printer 23. The photo printing film-coating unit 23 is used in the case of a pre-manufactured unprinted photo album, which is prepared from various general plain papers or synthetic films which are not treated with a printing solution.

In other words, the photo printing film-coating unit 23 is intended to convert internal album papers, which are prepared by general plain papers, into photographic printing papers on which photographic images can be printed. The photo printing film-coating unit 23 is efficient in more stably maintaining the papers used as the internal album papers 12, thereby improving the storing quality of the papers.

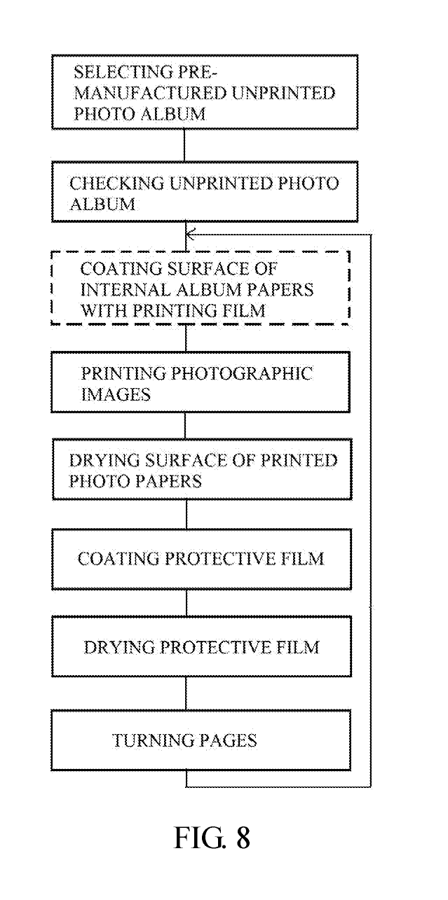

As shown in FIGS. 1 to 8, a method of manufacturing the photo album according to an embodiment of the present invention begins with alternately stacking the first reinforcing mounts 11 and the internal album papers 12, which can be folded and unfolded and on which photographic images are not printed, and attaching the adjacent surfaces of the first reinforcing mounts 11 and the internal album papers 12 to each other using an adhesive.

Subsequently, the internal album papers 12 are folded, and the stacked and bound region of the folded internal album papers 12 and the first reinforcing mounts 11 and the outermost surfaces of the internal album papers 12 are surrounded by the U-shaped reinforcing fabric straps 13, which include the first and second fixing portions 13a and 13b. Thereafter, the first and second fixing portions 13a and 13b of the reinforcing fabric straps 13 are attached to the first reinforcing mounts 11 and the internal album papers 12 by means of an adhesive.

Thereafter, the album cover sheet 14, which includes the first and second support layers 14a and 14b, the third support layer 14c and the surface skin layer 14d, is adhesively attached to the internal album papers 12 such that the album cover sheet 14 surrounds the internal album papers 12 and the reinforcing fabric straps 13, thereby completing the manufacture of the pre-manufactured unprinted album on which photographic images are not printed.

When a customer selects a preferred one of the unprinted albums 10, which have been previously manufactured by a manufacturer so as to have various designs, the selected unprinted albums 10 are introduced into the album-manufacturing apparatus 20 including the transfer conveyer 20a.

At this time, the unprinted photo album 10, which is introduced into the album-manufacturing apparatus 20, is maintained in the opened state, and the opened photo album 10 is consistently maintained in the horizontally balanced state by vertical movement of the first and second balancers 21 and 22, which are included in the album-manufacturing apparatus 20, as shown in FIG. 7 of the accompanying drawings.

Subsequently, the unprinted photo album 10 is supplied to the transfer conveyer 20a of the album-manufacturing apparatus 20 while the internal album papers 12 are opened. After each internal album paper is turned, ink solution is jetted from the nozzle of the printer 23 onto the respective print surfaces of the internal album papers 12 so as to print photographic images on the internal paper.

As the internal album papers 12 are turned while being printed with photographic images, the heights of both sides of the pre-manufactured unprinted photo album 10 become different from each other. At this time, the height difference between the both sides, which is caused by turning the internal album papers 12, is compensated for by the vertical movement of the first and second balancers 21 and 22, which are included in the album-manufacturing apparatus 20, whereby the effective gap between the printed surface of the internal album papers 12 and the nozzle of the printer 23 for jetting ink solution is consistently maintained. Consequently, respective internal album papers, which have been turned, may be consistently printed with the respective ink solutions.

When photographic images are completely printed on the respective internal album papers 12 using the ink solution jetted from the nozzle while the balanced condition in the effective gap is maintained, the internal album papers 12, which are opened and contain the photographic image printed thereon, are transferred to the first dryer 24 through the transfer conveyer 20a. Thereafter, the photographic images printed on the internal album papers 12, that is, the ink solution jetted from the nozzle so as to print the photographic images on the internal album papers 12 is dried in the first dryer 24.

Subsequently, when the pre-manufactured photo album 10, which contains the photographic images printed thereon, is transferred to a protective film-forming process through the transfer conveyer 20a, the coater 25, which is provided in the protective film-forming process, coats the printable surface of the internal album papers 12, on which the photographic images are printed, with a protective film. The photo album 10, which has been coated with the protective film, is transferred to the second dryer 26 through the transfer conveyer 20a. The second dryer 26 dries the protective film applied to the printable surface on which the photographic images are printed, thereby finally providing the finished photo album on which the photographic images requested by the customer are printed.

Specifically, in the photo album according to the embodiment of the present invention, since the reinforcing fabric straps 13 are not adhesively attached to the album cover sheet 12 but are adhesively attached to the first reinforcing mounts 11 and the internal album papers 12 even though the first and second support layers 14a and 14b of the album cover sheet 14 are adhesively attached to the internal album papers 12, as shown in FIGS. 4 to 6, the album cover sheet 14 or the internal album papers 12 to which the first reinforcing mounts 11 are adhesively attached and on which the photographic images are printed may be smoothly turned. In addition, since the reinforcing fabric straps 13 do not interfere with the album cover sheet by virtue of the presence of the U-shaped space A defined by the album cover sheet 14, the stacked and bound region of the first reinforcing mounts 11 and the internal album papers 12, which are adhesively attached to the reinforcing fabric straps 13 may not be broken and may be maintained in the securely bound state.

### INDUSTRIAL APPLICABILITY

While the technical idea of the pre-manufactured unprinted photo album on which photographic images can be printed and the apparatus and method for manufacturing a photo album using the same according to the present invention have been described with reference to the accompanying drawings, it should be construed as merely illustrating the most preferred embodiment of the present invention without limitation to the present invention.

Accordingly, the present invention is not limited to the above-described specific preferred embodiment, and any and all modifications, variations or equivalent arrangements will be made by those skilled in the art without departing from the spirit and scope of the invention. The modifications, variations or equivalent arrangements should be construed as falling within the scope of protection of the present invention, which is determined based on the claims.

What is claimed is:

1. A pre-manufactured unprinted photo album on which photographic images are to be printed, comprising;
a plurality of first reinforcing mounts;
a plurality of internal album papers, each of which is folded along a central folding line thereof, inner surfaces of the folded internal album paper, which face each other, serving as printable surfaces on which photographic images are to be printed and outer surfaces of the folded internal album paper, which are opposite the inner surfaces, being attached to the first reinforcing mount by means of an adhesive;
a U-shaped reinforcing fabric strap, which includes a first fixing portion, which is adhesively attached to outer surfaces of folded portions of the internal album papers so as to surround the outer surfaces when the plurality of internal album papers and the plurality of first reinforcing mounts are stacked with each other, and second fixing portions, which extends from both lateral ends of the first fixing portion and are attached to outermost ones of the plurality of internal album papers so as to surround outer surfaces of outermost ones of the first reinforcing mounts; and
an album cover sheet, which defines a U-shaped non-adhesive space for accommodating the reinforcing fabric strap and covers the reinforcing fabric strap, which surrounds the central folded portions of the internal album papers, the album cover sheet including first and second support layers serving as front and rear cover plates, a third support layer serving as an intermediate cover plate and a surface skin layer enveloping the first to third support layers, the surface skin layer having folding portions, which are positioned between the first to third support layers so as to be flexibly bent, and adhesively attaching inner surfaces of the first and second support layers to the internal album papers.

2. The pre-manufactured unprinted photo album according to claim 1, wherein first and final papers of the plurality of internal album papers are provided with second reinforcing mounts adhesively attached to surfaces thereof contacting the album cover sheet so as to reliably maintain the contacting surfaces in the attached state.

3. The pre-manufactured unprinted photo album according to claim 1, wherein the plurality of internal album papers are made of papers or synthetic films which are not treated with a printing solution, and the inner surfaces of the plurality of internal album papers are coated with an aqueous gelatin solution so as to form printable surfaces.

4. The pre-manufactured unprinted photo album according to claim 3, wherein the aqueous gelatin solution is prepared by mixing water and gelatin at a volume ratio of 80˜120:1.

5. The pre-manufactured unprinted photo album according to claim 1, wherein the folded portion of each of the plurality of internal album papers forms a folding extension having a semicircular cross-section and extending beyond a width of the first reinforcing mounts so as to accommodate a thickness of the first reinforcing mount and the thickness of the reinforcing fabric strap surrounding a stacked and bound portion of the internal album papers and the first reinforcing mounts when the internal album paper is unfolded in the state in which the photo album is finished.

6. The pre-manufactured unprinted photo album according to claim 1, wherein the album cover sheet includes the first and second support layers, which are adhesively attached to outermost surfaces of the internal album papers and have a predetermined thickness, the third support layer, which is disposed between the first and second support layers with predetermined distances therebetween and which surrounds the reinforcing fabric strap and has a predetermined thickness, and a surface skin layer, which is attached to the first to third support layers so as to connect them to each other and which is provided between the first and second support layers and the third support layer with folding portions B, which have a smaller thickness than that of the support layers and are not attached to the internal album papers.

7. The pre-manufactured unprinted photo album according to claim 6, wherein the surface skin layer includes a mesh layer attached to surfaces of the first to third support layers, a cushion layer, which is disposed on a surface of the mesh layer so as to provide a cushioning function, and an outer skin layer, which is disposed on a surface of the cushion layer and has a predetermined stretching property.

8. An apparatus for manufacturing a photo album, comprising:
a printer for printing photographic images on a printable surface of an opened pre-manufactured photo album transferred through a transfer conveyer by jetting printing ink onto the printable surface through a nozzle thereof, the photo album being bound and not being printed with photographic images;
a page-turning unit for, after the photographic images are printed on the printable surface of the opened photo album, turning a next paper of the photo album so as to print photographic images on a next page;
first and second balancers for supporting an album cover sheet of the pre-manufactured unprinted photo album while moving vertically such that a height difference between both sides of the photo album, which is formed when pages of the internal album papers are turned one by one by the page-turning unit and are printed with photographic images, is compensated for, whereby an effective gap between the printable surface and a nozzle for jetting printing ink is maintained consistent;
a first dryer for, after the internal album paper is printed with the photographic images in the state in which the balanced state between both sides of the photo album is maintained, drying the photographic images printed on the internal album paper;
a coater for coating the printable surface, which has been provided with the photographic images dried by the first dryer, with a protective film; and
a second dryer for drying the printable surface, which has been coated by the coater.

9. The apparatus according to claim 8, wherein, when the pre-manufactured photo album, which is not printed with photographic images and bound, is sequentially transferred to the printer, the first dryer, the coater and the second dryer along the transfer conveyer so as to be dried and coated with the protective film, the first and second balancers maintain the both sides of the photo album in the balanced state.

10. The apparatus according to claim 8, further comprising a photo printing film-coating unit, which is disposed in front of the printer.

11. The apparatus according to claim 8, wherein the printer is an inkjet-type flat-board printer.

12. The apparatus according to claim 8, wherein the coater includes a patterning unit, which makes a coating thickness of a protective film uniform or provides a protective film having various shapes and images in order to provide a printed photograph with a steric effect or a catadioptric effect.

13. A method of manufacturing a photo album, comprising:
a first operation of selecting a pre-manufactured unprinted photo album, which is bound in a state of not being printed with photographic image;
a second operation of checking the pre-manufactured unprinted photo album, which has been selected in the first operation;
a third operation of placing the pre-manufactured unprinted photo album, which has been checked in the second operation, on a transfer conveyer of a photo album-manufacturing apparatus so as to open internal album papers of the photo album, and printing photographic images on a printable surface of the opened internal album papers;
a fourth operation of drying the printable surface of the internal album papers, on which the photographic images have been printed in the third operation;
a fifth operation of coating the printable surface of the internal album papers having the photographic images printed thereon, which has been dried in the fourth operation, with a protective film having a predetermined thickness or pattern;
a sixth operation of drying the protective film, which has been applied to the printable surface in the fifth operation; and
a seventh operation of, after the sixth operation, repeating the third to fifth operations while sequentially turning pages of the internal album papers, thereby consecutively printing photographic images on printable surfaces of the internal album papers.

14. The method according to claim 13, further comprising an operation of maintaining equal heights of both sides of the internal album papers using first and second balancers while the printable surfaces of the internal album papers are consecutively printed with photographic images while the pages of the internal album papers are turned in the fourth and seventh operations.
